(19) United States
(12) Patent Application Publication
(10) Pub. No.: US 2011/0149269 A1
(43) Pub. Date: Jun. 23, 2011

(54) METHOD AND DEVICE FOR MEASURING THE SPEED OF A MOVABLE MEMBER RELATIVE A FIXED MEMBER

(76) Inventor: Tom Van Esch, Waterford, MI (US)

(21) Appl. No.: 12/971,009

(22) Filed: Dec. 17, 2010

Related U.S. Application Data
(60) Provisional application No. 61/287,229, filed on Dec. 17, 2009.

(51) Int. Cl. G01P 3/36

(52) U.S. Cl. 356/28

(57) ABSTRACT

A method and device for measuring relative speed of two members such as an automobile door and adjacent body structure with two laser sources spaced apart at a known spacing to successively illuminate a series of spots extending across an adjacent surface of the other member with the distance to each spot determined by sensors using laser triangulation. The time elapsed in generating the respective sets of signals is determined and the relative speed computed therefrom and displayed.

### CROSS REFERENCE TO RELATED APPLICATIONS

This application claims the benefit of U.S. provisional application No. 61/287,229 filed on Dec. 17, 2009.

### BACKGROUND OF THE INVENTION

This invention concerns determining the speed of a movable member with respect to a relatively fixed member. There is a particular need for such measurements in automobile production where the speed of closing of a door of an automobile needs to be accurately measured as part of quality control inspections.

Currently available optical systems such as shown in FIGS. 1-3 for such applications include two separate components. A first component 10 contains one or more measurement sensors, and is mounted on fixed member 12 next to a movable member 14 of which the relative speed needs to be measured. A second target component 16 provides a reference structure, for example in the shape of the two legged piece shown or other optical target which provides spaced apart well defined features A, B and is mounted on the moving member 14. The separate target features A, B on the second component 16 are detected by sensors on the first component 10 as the movable member 14 swings past the fixed member 12.

Typically there are two triggers provided by one sensor and two target features or two sensors and one target feature. The distance D between the two features A, B is fixed and known and from the time delay T between sensing one feature A and the next feature B, a signal processor is capable of determining the average speed of the member 14 over that portion of the trajectory where the two target features A, B are traversed.

This technology requires the second component 16 as the sensors may be unable to reliably detect with satisfactory precision features formed by the shape of the member 14 itself due to the wide variety of shapes, materials and colors of such members.

This two component arrangement has a major disadvantage as the operator needs to install two units and ensure their relative alignment so that the sensor can pick up the reference targets during the motion of the movable member.

Other available technologies such as radar or other Doppler systems have numerous practical limitations with respect to the environment in which a commercial system has to work. For example, a typical automotive production line has a numerous air pressure operated tools and these are a major source of disturbance and error for those systems.

Magnetic or proximity sensors also have the disadvantage of being only applicable to a limited number of applications, as for example only on steel doors and do not apply to aluminum or plastic doors. Furthermore, there may be problems with the reliability of triggering the sensor by a single feature on the door.

It is the object of the present invention to provide an optical method and device for measuring the relative speed between two relatively movable members which requires only a single component mounted on one of the members.

### SUMMARY OF THE INVENTION

The above object and other objects which will be understood upon a reading of the following specification and claims are achieved by a self-contained device mounted to one member which includes a first laser beam source/sensor which is capable of two dimensionally scanning the surface of the side of a second on facing side of the relatively movable member to create signals corresponding to the profile of the surface. A second laser beam source/sensor spaced from the first laser beam source/sensor along the direction of relative movement is also able to scan and obtain a series of points defining the surface profile and thus from the known distance apart of the two laser beam source/sensors and the time which elapses in sensing the presence of the profile between the two sensors, the relative speed between the two members is readily and reliably determined and can be indicated to the use by a numeric display included in the device.

### DESCRIPTION OF THE DRAWINGS

FIG. 1 is a pictorial simplied view of a prior art speed measuring optical system mounted to two relatively movable members.

FIG. 2 is a plan view of the two components of the prior art optical system shown in FIG. 1

FIG. 3 is a plot of the sensor electrical output signals with time of the prior art system shown in FIG. 1.

FIG. 4 is a pictorial representation of a speed measuring device according to the present invention installed on one member and located opposite another relatively movable member so as be capable of measuring the relative speed between the two members.

FIG. 5 is an enlarged plan view diagram of one component of the device shown in FIG. 4.

FIG. 6 is a plot of a typical electrical output signal of the component shown in FIG. 5.

FIG. 7 is an enlarged diagrammatic top view of the device depicted in FIG. 4.

FIG. 8 is a plot showing typical output signals from respective sensors included in the device depicted in FIGS. 4 and 7.

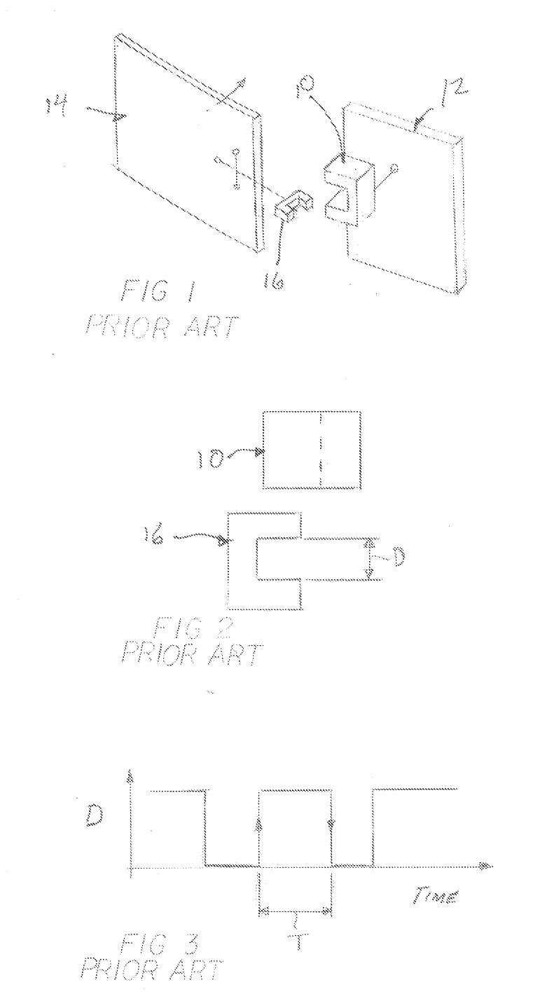

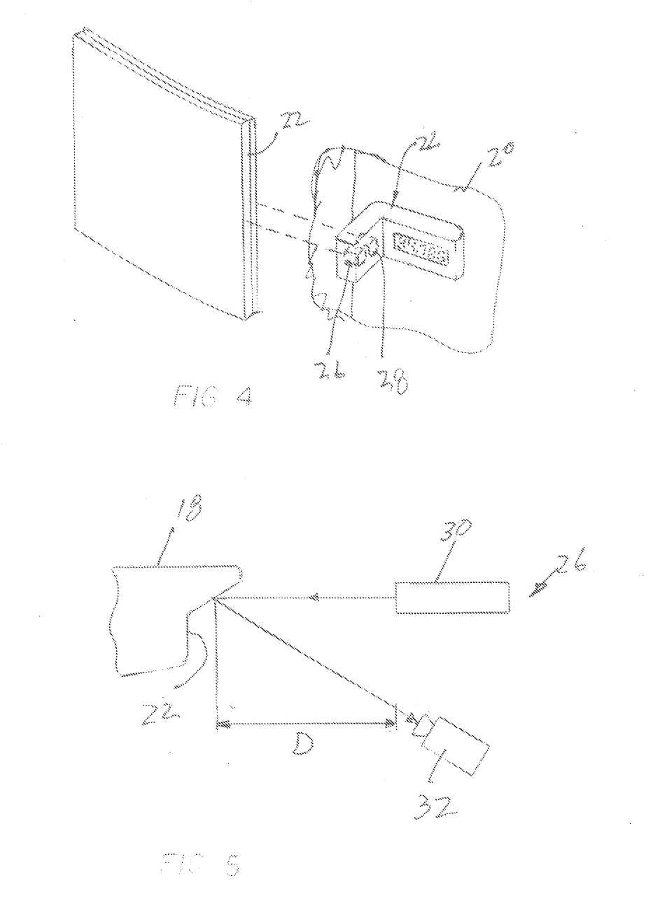

### DETAILED DESCRIPTION

In the following detailed description, certain specific terminology will be employed for the sake of clarity and a particular embodiment described in accordance with the requirements of 35 USC 112, but it is to be understood that the same is not intended to be limiting and should not be so construed inasmuch as the invention is capable of taking many forms and variations within the scope of the appended claims.

Referring to the drawings, and in particular FIG. 4, a movable member 18 such as an automobile door is juxtaposed next to a fixed member 20, such as an adjacent body structure.

The movable member has a contoured side surface 22 facing the adjacent fixed member 20.

An optoelectronic device 24 according to the present invention is mounted to fixed member 20, as by a suction cup, a magnetic mount, or other temporary readily attachable and detachable means (not shown).

The device 24 includes two side-by-side combination laser source-sensor units 26, 28 spaced apart on a housing 25 at a fixed spacing S in the direction of relative motion of member 18.

Such laser/sensor combinations are well known and may include a laser diode 30 (FIG. 5) which projects a laser light beam onto spots series of on the side surface 22 of the movable member 18 as it swings past the device 24.

A part of the diffuse reflected light is imaged by a sensor 32 through an optical lens system onto a CMOS or CCD sensing element. A signal processor 34 provide by a suitably programmed chip controller calculates the distance D to the spot on the side surface 22 using the well known laser triangulation distance determination.

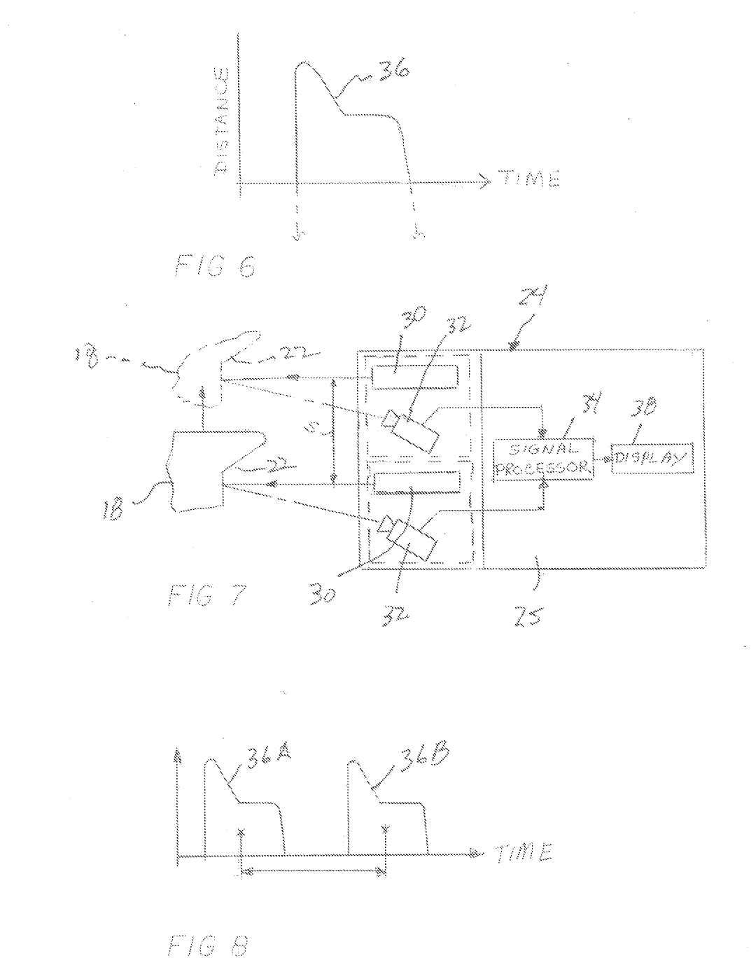

A set of electronic signals 36 is thereby generated which correspond to the profile of the traversed side surface 22 as seen in FIG. 6.

The units 26, 28 successively produce such sets of electronic signals as the member 18 moves past the device 24. By analyzing these respective sets of signals, 36A, 36B to correlate the two profiler images which correspond to the electronic signal sets, an elapsed time is computed in the signal processor 34 included in the device 24. By determining the time T one profile would need to be shifted to be aligned with the other, the relative speed can be computed from the fixed known spacing S between the two units 26, 28.

The numeric value computed is shown in a display 38 also included in the device 24. Since the same profile of the side surface 22 is determined by each laser-sensor unit 26, 28, the positions of the door as it moves past each unit 26, 28 can be reliably and accurately determined with a single device 24. The device may be calibrated to recognize the side surface profile of the particular member 18.

The various configurations of such doors, the materials from which it is made, the surface finish, etc. do not affect the accuracy, such that only a single device is required, eliminating the need for set up and alignment of two separate components.

In order to avoid possible interference between the two laser sources 30, the beam from each source 30 may be modulated so that the receiving sensors 32 can distinguish between the light emitted by the two laser beam sensors 30.

The device 24 is preferably battery operated and wirelessly connected to calibration instruments and tolerance programming devices (not shown) on computer for logging the results into a station database for better study or reliance to further simplify the installation and set up process.

A single wide angle sensor may be sued for both laser sources, but this is not preferred.

1. An optoelectronic device comprising:
a pair of laser source-sensor units spaced apart side by side at a fixed spacing on a housing;
each unit including a laser beam source and a sensor able to image reflected light from a surface of a member onto which a spot of laser light is projected; a signal processor associated with each unit and a generating signal sets corresponding to the distances from each laser source to said spot on said member from said images of said spot at successive time intervals to correspond to a profile of said surface; said signal processor receiving both said set signals corresponding to said contours from both units and determining the time elapsing between the generation of said respective set of signals corresponding to said profile from successive sensed distances to said surface of said member, and computing therefrom the velocity of said member relative said device; and
a display on said housing receiving the results of said computation and displaying a numeric value of said speed.

2. A method of determining the speed of one member movable relative a second member and having a variably contoured surface adjacent said second member comprising:
a first and second laser sources on said second member spaced apart side by side at a fixed spacing, laser source each directing a laser beam at said contoured surface to illuminate a series of spots thereon as said one member moves past said surface;
imaging each of said spots to determine the distances to said surface as said first member moves past said second member by laser triangulation to create respective sets of electronic signals corresponding to the profile of said surface.
comparing the time at which said side surface moves successively past said first and second laser sources and determining therefrom and from the fixed spacing of said sources the speed of said first and second members;

3. The method according to claim 2 wherein each of said laser sources is provided by a unit having a sensor associated with a respective laser source to image the spots produced by an associated laser source.

4. The method according to claim 2 further including numerically displaying said determined velocity.

5. The method according to claim 2 wherein said first and second members comprise an automobile door and an adjacent body structure.
